(19) United States
(12) Patent Application Publication
(10) Pub. No.: US 2004/0029697 A1
(43) Pub. Date: Feb. 12, 2004

(54) Solid bowl screw centrifuge comprising a distributor

(76) Inventors: Jurgen Hermeler, Haltern (DE); Paul Bruning, Oelde (DE); Ludger Horstkotter, Ennigerlob (DE)

Correspondence Address: Barnes & Thornburg, 750 17th Street NW, 9th Floor, Washington, DC, 20006, US

(21) Appl. No.: 10/416,548

(22) PCT Filed: Oct. 9, 2001
(86) PCT No.: PCT/EP01/11663

(30) Foreign Application Priority Data
Nov. 14, 2000 (DE) 100 65 893.8
Apr. 28, 2001 (DE) 101 20 995.9

(51) Int. Cl. B04B 1/20

(52) U.S. Cl. 494/53

(57) ABSTRACT

The invention relates to a solid bowl screw centrifuge comprising a centrifuging chamber (19) having a rotating screw (1) and a likewise rotating drum (21) surrounding the centrifuging chamber (19), in addition to a distributor (15) which is preferably embodied as a tube and is used to introduce the material to be centrifuged (S) into the centrifuging chamber (19). Said distributor is oriented in a angular manner, especially perpendicularly, in relation to the central axis (A) of the screw (1). The material to be centrifuged is guided through an axially extending inflow tube (13) into the distributor (15). At least one wall (15a) of the distributor is provided with a surface structure consisting of projections (27) in such a way that the main part of the material to be centrifuged (S) which passes through the distributor must flow around at least one of the projections (27) on the at least one wall (15a) on the radial path from the inflow tube (13) to the centrifuging chamber (19).

The invention relates to a solid bowl screw centrifuge having a rotating drum which surrounds a centrifuging chamber having a screw which also rotates, and having a distributor preferably constructed as a tube for introducing the material to be centrifuged into the centrifuging chamber, which distributor is oriented in an angular manner, particularly perpendicularly, with respect to the center axis of the screw, the material to be centrifuged being guided through an axially extending inflow tube into the distributor.

In the case of solid bowl screw centrifuges, the material to be centrifuged is to be accelerated to the circumferential speed of the screw at the diameter of the liquid level (surface) in the screw channel. In this case, the relative velocity at the entry into the centrifuging chamber (liquid surface) is to be as low as possible.

As a result of the acceleration to the circumferential speed of the screw at the liquid level diameter on the driving walls (of the distributor), a surface flow is created in the distributor whose velocity increases considerably with the radius, specifically to a value which is approximately equal to the circumferential speed of the screw at the liquid level diameter.

From U.S. Patent Document U.S. Pat. No. 5,403,486, it is known to provide the area of the feeding of material to be centrifuged—thus, in the widest sense of the word, the distributor—of a solid bowl screw centrifuge with a larger number of outlet openings which are aligned at various angles with respect to one another. However, this solution requires relatively high expenditures; in addition, no lowering of the relative velocity is achieved.

From German Patent Document DE 1 293 089, it is known to cover nozzle-type distributor openings in the centrifuging chamber by means of a baffle plate which deflects the material to be centrifuged in order to reduce flows. However, this measure is not sufficient for an effective reduction of swirls.

It is therefore an object of the invention to further develop the solid bowl screw centrifuge of the above-mentioned type such that the relative velocity of the material to be centrifuged is reduced in a constructively simple manner when entering the liquid surface.

The invention achieves this task by means of the objects of claims 1, 2 and 20.

Advantageous further developments are indicated in the subclaims.

According to a first variant, at least one wall of the distributor is provided with a surface structure consisting of projections in such a manner that an essential portion of the material to be centrifuged flowing through the distributor must flow around at least one of the projections on this at least one wall on this essentially radial path and/or a path which extends essentially in the direction of the centrifugal force, from the inflow tube into the centrifugal chamber.

According to another variant, at least one wall of the distributor is provided with a surface structure consisting of at least two or more radially mutually offset rows of projections. The projections of the rows are axially offset with respect to one another such that essentially no radial free flow channels are formed on the wall.

As a result of these variants, it is ensured in an effective and nevertheless simple and relatively inexpensive manner that at least the essential portion of the material to be centrifuged, but preferably the entire material to be centrifuged can no longer flow in a direct radial path out of the inflow tube into the centrifugal chamber. Here, the word “radial” applies to the direction on the distributor wall in which the material to be centrifuged will essentially flow into the centrifuging chamber during the rotation of the distributor as a result of the centrifugal force; that is, the term “radial” may also comprise an axial movement component and/or a circumferential component. It is important that at least the essential portion of the material to be centrifuged does not flow directly “in the direction of the centrifugal force” into the centrifuging chamber.

Although it is known from German Patent Document DE PS 1 272 231 to construct several grinding (crushing) bodies on the distributor wall, direct paths radially into the centrifuging chamber still exist between these bodies so that the liquid is essentially not braked but enters the centrifuging chamber at an unchanged high velocity. The possibility of a benefit of projections for reducing the relative velocity of the material to be centrifuged when entering into liquid surface in a constructively simple manner was not recognized here.

According to a constructively particularly simple and nevertheless especially effective variant, the projections are constructed as circular, rhombic or other n-cornered knobs.

In another variant, in contrast, the projections have a meander shape. In this case as well as according to additional embodiments, it is advantageous for the projections to be constructed as metal plates.

According to another variant, which can also be considered independently, at least one wall of the distributor is provided with a step-type surface structure which extends in the circumferential direction and which also causes a braking, among other things, as a result of swirls.

In the following, embodiments will be described in detail by means of the drawing.

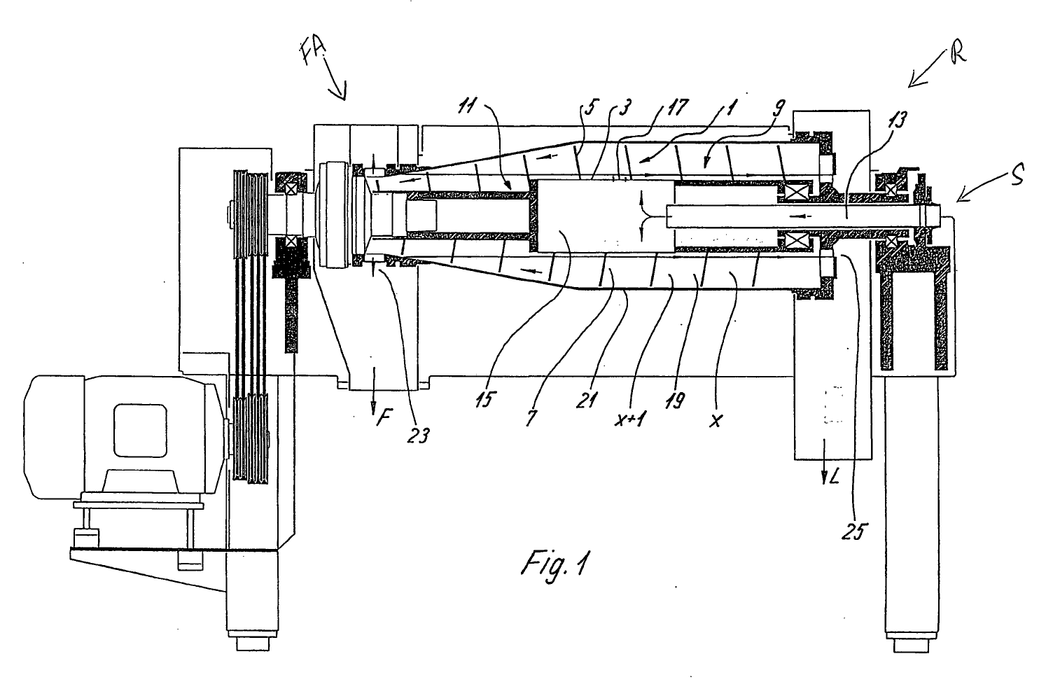

FIG. 1 is a sectional view of a solid bowl screw centrifuge;

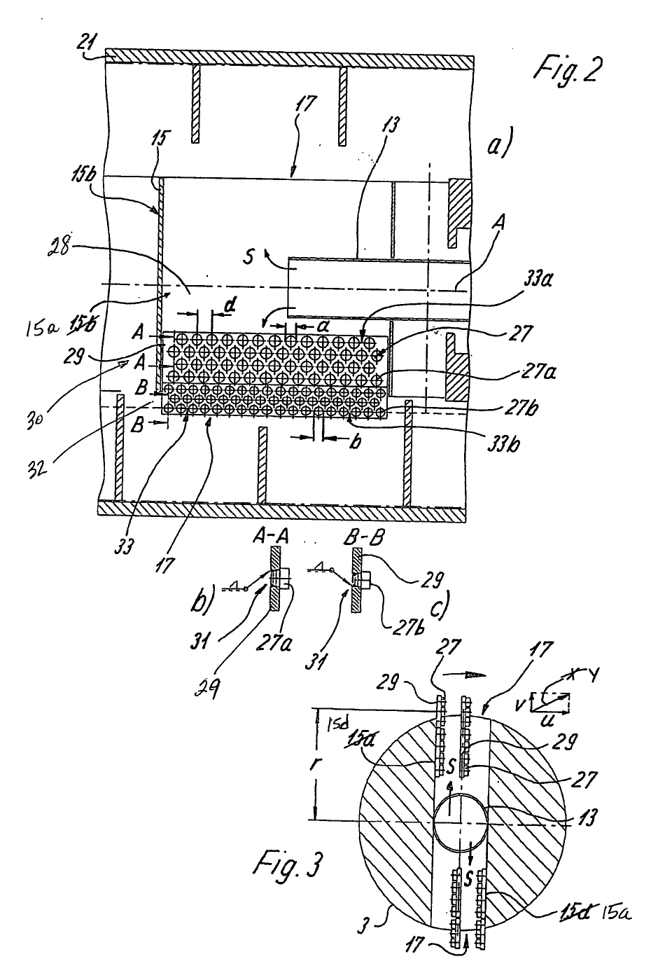

FIG. 2 is a view of the inflow area of a distributor into a centrifuging chamber of a solid bowl screw centrifuge;

FIG. 3 is a schematic sectional view of the drum of FIG. 1;

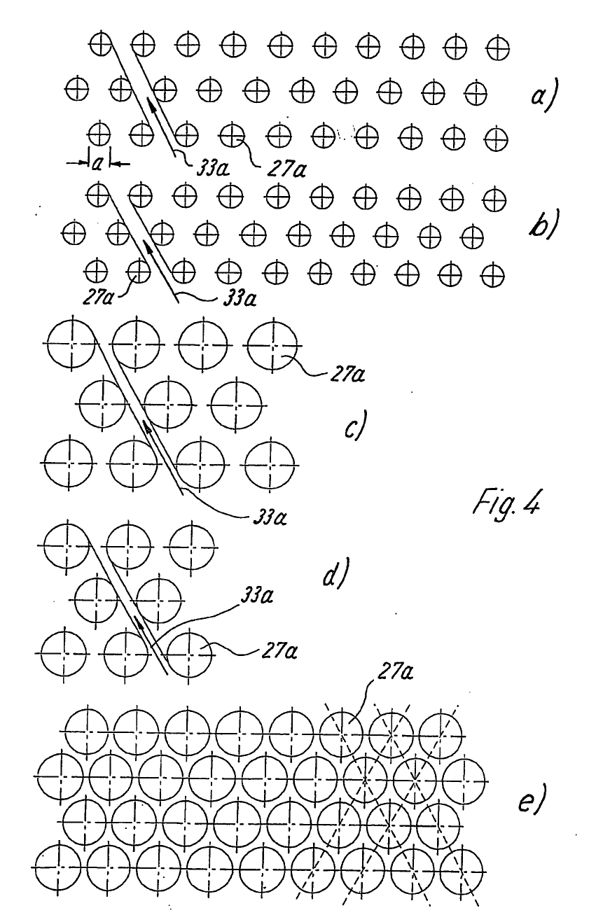

FIGS. 4a to e are views of various cylindrical knob arrangements;

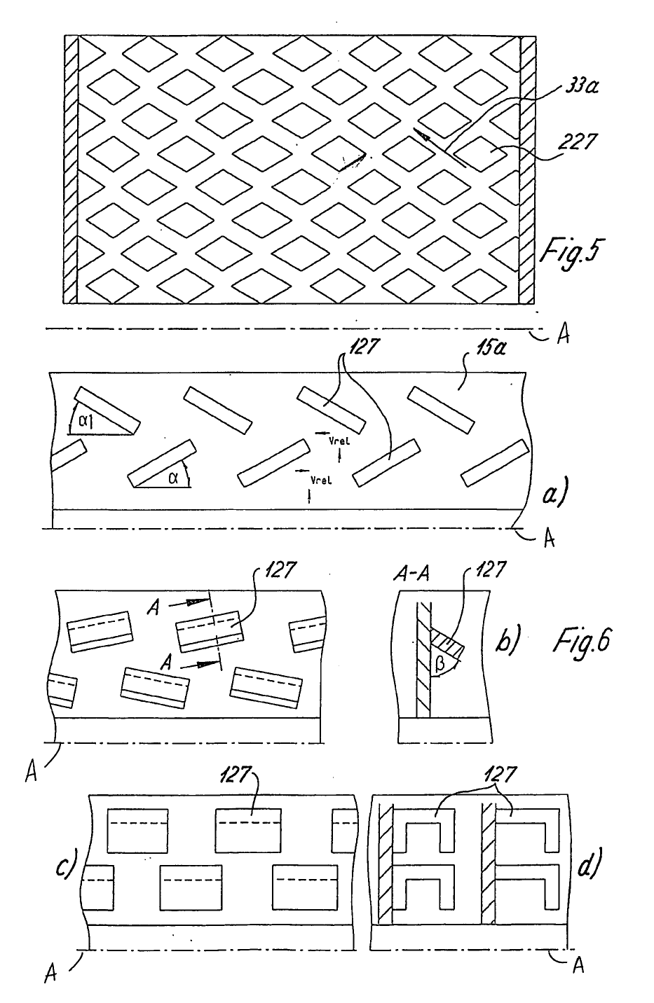

FIGS. 5 to 11 are views of various structures of projections on walls of distributors;

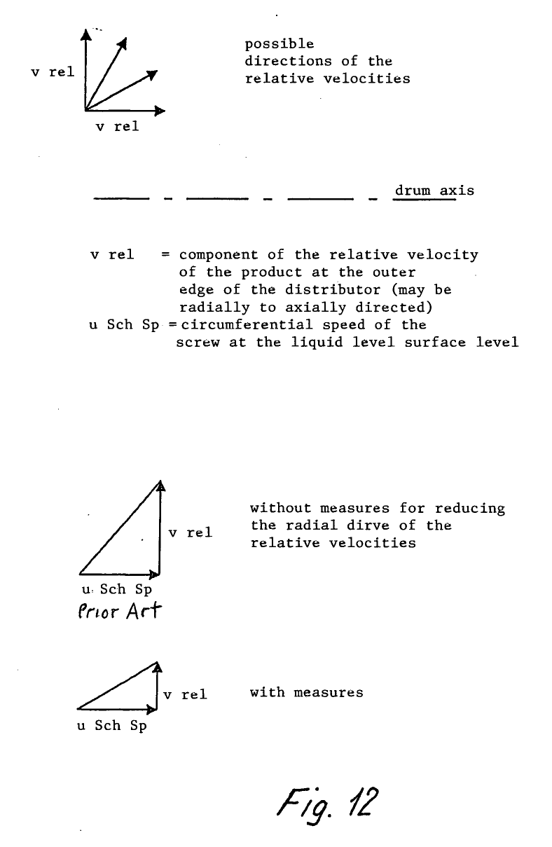

FIG. 12 is a diagram for illustrating the velocities of the material to be centrifuged.

FIG. 1 illustrates a solid bowl screw centrifuge with a screw 1 which has a screw body 3 as well as, in this case, a screw blade 5 which surrounds the screw body 3 in a helical manner. Between the screw spirals x, x+1, . . . , a screw channel 7 is constructed for conveying/transporting a material to be processed.

In its area which is in the rear in FIG. 1, the screw body 3 has a cylindrical section 9 and, in its forward area, which is adjoining in FIG. 1, the screw body 3 has a section 11 which tapers in steps (as an alternative, conically).

Material S to be centrifuged is guided through the centrally arranged inflow tube 13 into a distributor 15 and is guided from there through radial openings 17 in the distributor 15 into the centrifuging chamber 19 with the screw 1 and the drum 21 surrounding the screw 1.

The material S to be centrifuged is accelerated when passing through the distributor 15 and when entering into the centrifuging chamber 19. As a result of the effect of the centrifugal force, the solid particles will deposit on the drum wall within a very short time.

The screw rotates 1 at a slightly lower or higher speed than the drum 21 and conveys the centrifuged solids F toward the tapered section 11 out of the drum 21 to the solids discharge 23.

In contrast, the liquid L flows to the larger drum diameter at the rearward end of the drum 21 and is discharged there (overflow 25).

In the following, the constructive further development of the feeding of the material to be centrifuged from the inflow tube 13 into the centrifuging chamber 19 will be examined in detail—thus particularly the construction of the distributor 15.

In this respect, reference is first made to FIG. 2.

FIG. 2 again shows the inflow tube 13 which projects into the distributor 15 which here has an essentially rectangular cross-section (perpendicular to the plane of projection of FIG. 2) or is essentially constructed as a rectangular tube. Alternative constructions are naturally conceivable; thus, a construction of the distributor as a tube structure consisting of two mutually crossing rectangular tubes; or as tubes which are not oriented perpendicular to the drum axis but at an arbitrary angle thereto. Furthermore, cross-section geometries can be implemented which deviate from a rectangular cross-section.

At the moment of the exit from the inflow tube 13, the material S to be centrifuged entering the distributor 15 moves at the axial flow velocity in the inflow tube 13. When entering the distributor 15, it is then taken along by the distributor 15. The material S to be centrifuged therefore rotates along with the distributor 15 and thus moves essentially radially to the outside because of the centrifugal force in the distributor 15.

In the area of the openings 17 at the outer radial edge of the distributor 15, the material to be centrifuged has the absolute velocity x (see FIG. 3) at which it leaves the distributor (also see FIG. 3). The velocity vector x has a component u in the circumferential direction of the drum 21 as well as a component v—called relative velocity. The relative velocity v may contain a component in the radial direction as well as other components in other directions (for example, axial).

In the case of many products to be centrifuged, the relative velocity component v at the entry of the material to be centrifuged into the centrifuging chamber 19 should be as small as possible, for example, in the case of products which have a relatively high tendency to foam or have sensitive structures which must not be destroyed or damaged as in the prior art (such as flocculents, which should not be destroyed). Thus, in an ideal case, the material S to be centrifuged should enter into the centrifuging chamber only at the circumferential rotating speed of the screw body 3 and without relative velocity v.

In order to reduce the relative velocity v or in order to particularly prevent an excessive acceleration in the radial direction, it is provided to equip at least the walls 15a, d of the distributor, which, in the mutually opposite ends of the distributor 15, essentially take along the material to be centrifuged when the distributor 15 is rotated—or, in addition, equip the side walls 15b perpendicular thereto (or, as an alternative, all walls) of the distributor with a surface structure which, in particular, may consist of projections 27 formed directly on the wall 15a, d or formed on at least one separate metal plate 29 which can be mounted on the wall. A multilayer arrangement of several metal plates 29 which are situated above one another and have projections 27 can also be implemented (FIG. 3).

The projections 27 are distributed such on the at least one wall 15a of the distributor 15 that at least the predominant portion of the material S to be centrifuged which enters the distributor 15 has to flow around at least one, but preferably several of the projections 27 on the radial path to the outside.

For ensuring a sufficient “braking effect”, the at least one wall 15a is, in addition, preferably provided with projections 27 in essentially such a manner that essentially no radial (or perpendicularly outward-pointing) free flow paths 33 remain for the material to be centrifuged.

Preferably, the projections 27 are distributed on a surface of from 30 to 70% of the at least one wall 15a of the distributor 15.

In addition, the projections 27 are constructed at least in the radially outer area of the distributor wall 15a, d. This has the following advantage.

Since the centrifugal force acts proportionally to the square of the angular velocity and proportionally to the radius r (F_{z}=mω²r), it immediately becomes clear that the acceleration of the material to be centrifuged is higher in the outer radial area of the distributor 15 than in the inner area, so that in the outer radial area of the distributor 15a, the braking effect of the projections 27 counteracts this acceleration particularly advantageously. For this reason, the projections 27 are preferably also constructed to the outer radial edge of the distributor 15 or to the discharge opening 17 on the wall 15a of the distributor 27. The radially interior part of the distributor (for example, the interior 30 or 50% of the surface of the wall 15a), in contrast, may have a smooth, that is, projection-free construction without significantly reducing the “braking effect”.

Since the centrifugal acceleration also becomes higher with an increasing radius, a variant of the invention was found to be particularly advantageous in the case of which at least one or several wall(s) 15a, d of the distributor or the metal plate 29 placed upon the wall 15a projects by means of the projections 27 radially over the edge of the opening 17 into the centrifuging chamber.

According to FIG. 2, the projections 27 are constructed as cylindrical knobs 27a, b—preferably of a different diameter—which are fastened, for example, welded, in bores 31 of the wall 15a.

Alternative geometries are conceivable, such as triangular cross-sections, rectangular cross-sections, rhombuses, etc.

Furthermore, the projections 27 may expand or taper away from the wall 15a. Spherical shapes are also conceivable.

The projections 27 extend perpendicular to the distributor wall 15a such that, in the case of the respective preferred application (for example, the extraction of fruit juice) and, in the case of a maximal throughput of material to be centrifuged, the projections 27 are at least as high as the liquid level on the wall 15a. The projections are preferably approximately twice as high as the average liquid level.

As an alternative, the projections may be constructed as rods which penetrate the distributor 15 from the wall 15a to the opposite wall 15d.

The knobs 27 may also be constructed as pressed-out areas or may be constructed in a different manner directly in one piece with the wall 15a, d or the metal plate 29. This one-piece construction may also take place by casting or by a milling-out of the knob structure from a correspondingly thick wall plate.

According to FIG. 2, an interior radial area of the wall 15a is constructed without projections or knobs. This interior radial area is followed by a central radial area with four rows of knobs 27a aligned parallel to the drum axis A, each knob 27a having a first diameter a. The central area is, in turn, followed by an exterior area with three rows of knobs 27b which, in comparison to the diameter a, have a smaller diameter b and are also situated closer to one another, so that the flow channels 33b extending between the knobs 27b and aligned diagonally with respect to the drum axis A are narrower than the flow channels 33a remaining between the wider knobs 27a.

The knobs 27a, b are in each case arranged in rows which are aligned parallel to the drum axis A. The rows are arranged with respect to one another such that they are axially offset by half the distance between two adjacent knobs 27a, b, so that the material S to be centrifuged is prevented from flowing through directly in the radial direction. The axial distance d between the knobs 27a, b is slightly larger here than the diameter of the knobs 27a, b. The distance between the center points of the knobs in the radial direction corresponds approximately to their diameter a, b.

According to FIG. 2, the knobs 27 have a diameter which radially diminishes toward the outside in steps. In this case, the flow-through channels 33 also become smaller or narrower. This construction causes an increasing braking of the material to be centrifuged radially from the interior toward the exterior; that is, it counteracts the acceleration increasing as a result of the intensifying centrifugal force. In this case, the path which has to be covered by the material S to be centrifuged is extended by the knobs 27a, b.

FIGS. 4 to 10 show additional variants of knob structures.

According to FIG. 4a, the rows of knobs 27a are in each case arranged to be offset with respect to one another by the diameter of the knobs, the distance between the center points or center axes of the cylindrical knobs 27a in each row in each case corresponding to the diameter d of these knobs 27a.

The respective axial offset of the rows of knobs relative to one another is reduced from FIGS. 4a to FIG. 4d. In a direction diagonal to the drum axis A, this results in diagonally outward-pointing narrowing flow-through channels 33. These can also be completely avoided if the diameter of the knobs 27a, b is varied as in FIG. 2 or the offset of the rows of knobs is varied from row to row, or is still further reduced (see FIG. 4e). As a result of a suitable design of the knob rows, many varied flow-through characteristics can be achieved.

It is conceivable to produce the knobs by means of cup-shaped cutters. Many different materials, such as steel, cast metal or even plastic materials are conceivable for the knobs. Plastic has the advantage that the knobs will be easily bendable or movable, which may increase the braking effect.

FIG. 4e shows a variant in which the knobs of a row have such a narrow distance from one another that, in the case of an axial offset of the knob rows by half the distance between two adjacent knobs, no linear flow-through channels 33 remain which extend perpendicularly to the center axis A of the centrifuge.

According to FIG. 5, the projections have a rhombic shape. The connection lines of the tips of the rhombuses 227 are situated perpendicular and parallel to the center axis A of the centrifuge. Furthermore, the tips of the rhombuses 227 point to one another in the different rhombus rows, flow-through ducts 33 remaining between the rhombuses 227 in the diagonal or sloped direction with respect to the center axis. The flow ducts 33 or rhombuses 227 can be produced, for example, by milling.

FIG. 6a shows a variant of the invention in which, instead of rows of knobs, at least two rows of plate metal strips 127 are fastened to the wall 15a of the distributor.

These plate metal strips 127 are each angularly oriented with respect to the center axis A of the centrifuge and are situated so close to one another in mutually oppositely angularly offset rows that again no flow-through channels remain on the distributor wall in the radial direction but a considerable deflection and braking takes place. Here, the angle amounts to approximately 30°. The smaller the angle with respect to the center axis, the higher the velocity has to be, so that no deposits will form on the plate metal strips. It is also conceivable that the angle is reduced toward the outside, optionally to the 0 value.

It is also conceivable that the plate metal strips 127 are not situated perpendicularly on the screw body but at an arbitrary angle (see FIG. 6b) and/or are constructed and/or arranged in an L-shape or U-shape or T-shape (see, for example, FIGS. 6c and 6d). At high-speed locations, the angle with respect to the center axis should be larger than at lower-speed locations.

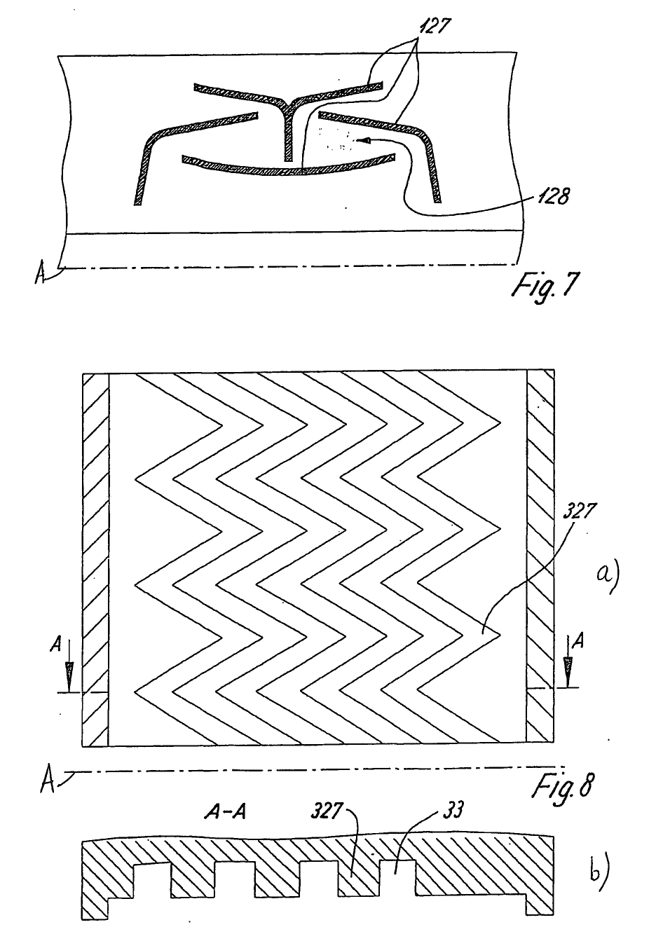

FIG. 7 illustrates a variant. A first, very flat metal plate 127 leads to an intensive braking into a labyrinth arrangement 128 consisting of additional bent metal plates 127 which are designed such that again no radial flow-through can take place.

According to FIG. 8, the projections have a type of meander shape. The zigzag-type meanders 327 engage in one another such that again no flow-through channels remain in the distributor 15 radially to the outside.

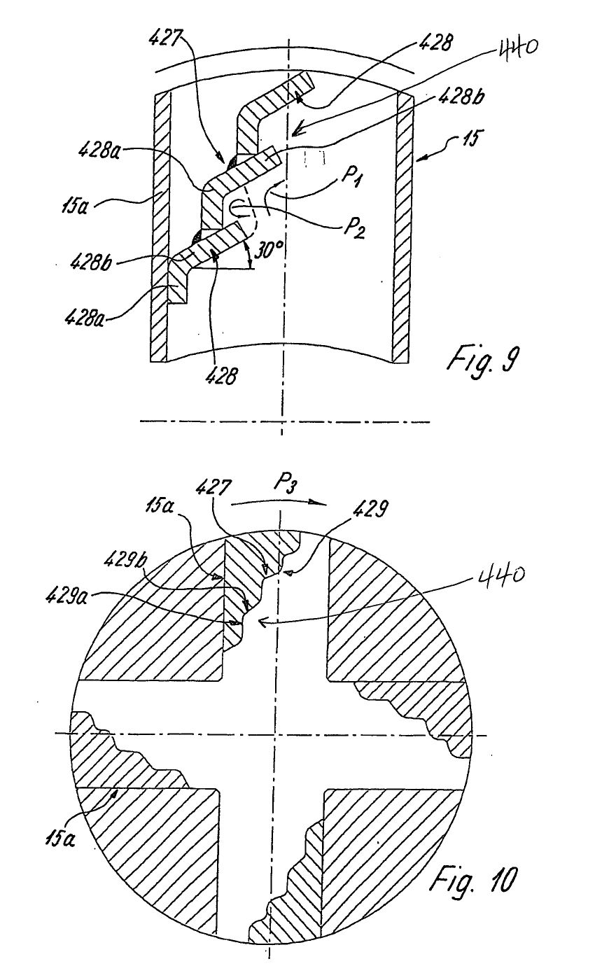

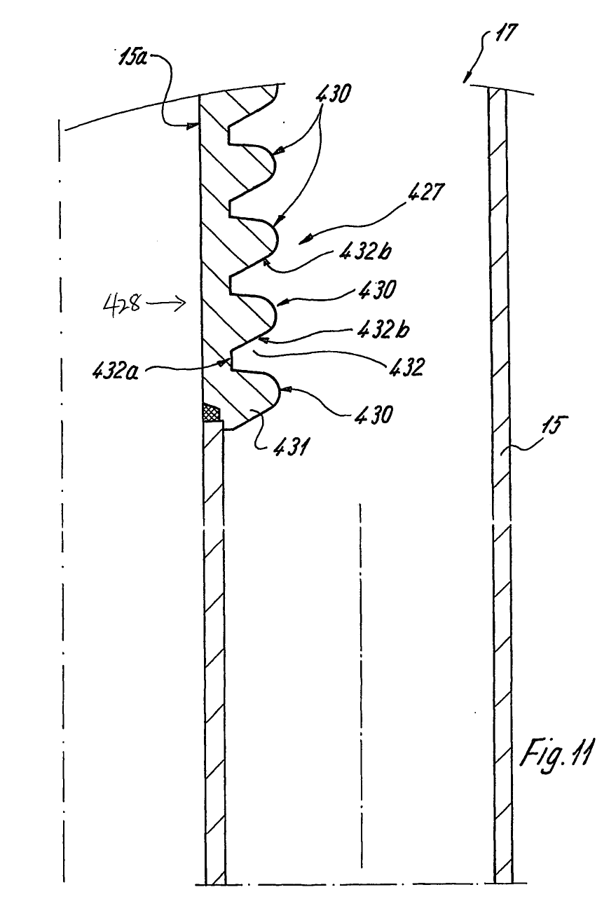

According to FIGS. 9 to 11, a type of step-shaped surface structure (step construction 427) was implemented in the distributor or on the walls 15a of the distributor shaft. In FIG. 9 as well as in FIG. 10, the liquid flow has to take place over “steps” in the circumferential direction. Here again, the effect will be optimal if the step construction extends into the liquid level.

According to FIG. 9, the step contour is produced of several metal plates 428; as an alternative, the contour may also be shaped from a workpiece (for example, milled).

The metal plates 428 have an angular cross-section; that is, they each consist of a section 428a which extends essentially parallel to the distributor wall, and of a section 428b which is angular thereto and which, as an example, has an inclination of approximately 30° to the perpendicular line on the distributor wall.

The section 428a of the first metal plate 428, which extends essentially parallel to the distributor wall, is placed directly onto the distributor wall. The sections of the metal plates 428 which follow, which sections extend parallel to the distributor wall 428a, are in each case mounted on the back sides of the angular sections 428b of the preceding metal plates, so that a type of swirling space is formed between the successive metal plates 428.

This arrangement has the following advantages.

When the liquid stream from one step or one metal plate 428 impacts on the next step or the next metal plate 428, it is directed (in FIG. 9, to the left and right) in the flow direction and against the latter into different directions and is swirled which, in turn, causes a braking effect.

Since the metal plates 428 are offset with respect to one another, the liquid stream moves slightly against the rotating direction (in FIGS. 9 and 10, to the right, arrow P3) along the broken line.

During the impact, the liquid is divided in the rotating direction and against the rotating direction (arrows P1, P2). This division and the swirling of the stream provides a particularly advantageous braking effect. The braking effect is virtually composed here of the effect of the diagonal sections of the metal plates 428 and the shadow effect of the swirlings (arrow P2).

FIG. 10 differs from FIG. 9 not only in that the step construction 427 was implemented in one piece as a cast or milled part but in that the step construction is designed such that the section 429a of the steps 429 extending essentially parallel to the distributor wall in each case adjoins the ends of the angular sections 429b of the preceding step, so that no swirling space is created between the successive steps.

FIG. 11 shows an alternative to FIGS. 9 and 10. In this figure, a “waterfall-type braking inflow” is implemented. Here also, a type of step contour 427 is implemented; however, here, the individual steps 430 are again formed by rows of projections 431 extending essentially parallel to the drum axis, or rows 432 grooves are milled into a plate. The rows 432 of grooves, in turn, have an angular cross-section; that is, they each consist of a section 432a extending essentially parallel to the distributor wall and of a section 432b which is at an angle thereto and which here has, for example, a slope of approximately 30° to the perpendicular line on the distributor wall. The sections 432a of the rows of grooves, which each extend essentially parallel to the distributor wall, are essentially mutually aligned; that is, they are situated in a plane which reduces the costs of the manufacturing in comparison to the variant of FIG. 10 (less waste during the milling or less required casting material). The example illustrated here has the advantage that the diagonal section 432b has an angle of approximately 30° with respect to the perpendicular line on the distributor wall and that the impacting of the liquid stream on the next step also takes place at an angle of, for example, 30°.

List of Reference Numbers

| | |
|---|---|
| Screw | 1 |
| screw body | 3 |
| screw blade | 5 |
| screw channel | 7 |
| cylindrical section | 9 |
| tapering section | 11 |
| inflow tube | 13 |
| distributor | 15 |
| walls | 15a-d |
| discharge openings | 17 |
| centrifuging chamber | 19 |
| drum | 21 |
| solids discharge | 23 |
| overflow | 25 |
| projections | 27 |
| knobs | 27a, b |
| metal plate | 29 |
| bores | 31 |
| flow-through channels | 33 |
| plate metal strip | 127 |
| labyrinth arrangement | 128 |
| rhombuses | 227 |
| meander | 327 |
| step construction | 427 |
| metal plates | 428 |
| sections | 428a, b |
| steps | 429 |
| steps | 430 |
| projections | 431 |
| rows of grooves | 432 |
| sections | 432a, b |
| drum axis | A |
| material to be centrifuged | S |
| diameter: knobs | a, b |
| distance between knobs axial | d |
| screw spiral | x, x + 1, . . . |
| material to be centrifuged | S |
| solid | F |
| liquid | L |
| radius | r |
| angle of slope | α, α1 |
| arrows | P1-P3 |

1. Solid bowl screw centrifuge having
a rotating drum (21) which surrounds a centrifuging chamber (19) having a screw (1) which also rotates,
having a distributor (15) preferably constructed as a tube for introducing the material (S) to be centrifuged into the centrifuging chamber (19), which distributor (15) is oriented in an angular manner, particularly perpendicularly, with respect to the center axis (A) of the screw (1),
the material to be centrifuged being guided through an axially extending inflow tube (13) into the distributor (15),
characterized in that
at least one wall (15a) of the distributor is provided with a surface structure consisting of projections (27) in such a manner that an essential portion of the material (S) to be centrifuged flowing through the distributor must flow around at least one of the projections (27) on this at least one wall (15a) on this essentially radial path and/or a path which extends essentially in the direction of the centrifugal force, from the inflow tube (13) into the centrifugal chamber (19).

2. Solid bowl screw centrifuge, particularly according to claim 1, characterized in that the at least one wall (15a) of the distributor is provided with at least two or more radially mutually offset rows of projections (27), the projections (27) of the rows being axially offset with respect to one another such that essentially no radial flow channels and/or flow channels which extend essentially in the direction of the centrifugal force are formed on the wall (15a).

3. Solid bowl screw centrifuge according to claim 1 or 2, characterized in that the projections are constructed as cross-sectionally circular, rhombic or other n-cornered knobs (27).

4. Solid bowl screw centrifuge according to claim 1 or 2, characterized in that the projections (227) have a meander shape.

5. Solid bowl screw centrifuge according to claim 1 or 2, characterized in that the projections (127) are constructed as plate metal strips and/or are produced by welding, milling or the like.

6. Solid bowl screw centrifuge according to one of the preceding claims, characterized in that the plate metal strips (127) are each angularly oriented—preferably at 30°—with respect to the center axis A of the centrifuge and are situated so close to one another in rows, particularly in mutually angularly offset rows that no flow-through channels remain on the distributor wall in the radial direction.

7. Solid bowl screw centrifuge according to one of the preceding claims, characterized in that the angles (α) preferably decrease between the plate metal strips (127) and the center axis A with an increasing radius of the distributor (15) or with an increasing distance from the drum axis.

8. Solid bowl screw centrifuge according to one of the preceding claims, characterized in that the plate metal strips (127) form a labyrinth to the centrifuging chamber.

9. Solid bowl screw centrifuge according to one of the preceding claims, characterized in that the knobs (27) have a contour which tapers or widens from the wall of the distributor (15), or which is circular or spherical, or which has a constant diameter.

10. Solid bowl screw centrifuge according to one of the preceding claims, characterized in that the knobs (27) are constructed in one piece with the wall (15a) or the metal plate (29).

11. Solid bowl screw centrifuge according to one of the preceding claims, characterized in that the knobs (27) are welded into bores of the metal plate (29) or of the wall (15a).

12. Solid bowl screw centrifuge according to one of the preceding claims, characterized in that the knobs (27) have such a height essentially perpendicularly to the wall (15a) that, in the case of a maximal throughput of material (S) to be centrifuged, the liquid level at the wall (15a) is lower than the height of the knobs.

13. Solid bowl screw centrifuge according to one of the preceding claims, characterized in that the diameter and/or the spacing of the knobs (27) decreases radially toward the outside.

14. Solid bowl screw centrifuge according to one of the preceding claims, characterized in that the diameter and/or the spacing of the knobs (27) is constant radially toward the outside.

15. Solid bowl screw centrifuge according to one of the preceding claims, characterized in that the wall (15a) provided with the projections or the metal plate (29) on the wall together with projections extend over the circumferential wall of the screw body into the centrifuging chamber (19).

16. Solid bowl screw centrifuge according to one of the preceding claims, characterized in that the projections (27) are formed at least in the exterior radial area of the distributor (15).

17. Solid bowl screw centrifuge according to one of the preceding claims, characterized in that the surface structure with the projections (27) covers at least 40% of the surface of the wall (15a).

18. Solid bowl screw centrifuge according to one of the preceding claims, characterized in that several mutually stacked layers of metal plates provided with the projections are arranged in the distributor (15) on the at least one wall (15a), so that the flow of material to be centrifuged which flows through the distributor is divided into several portions.

19. Solid bowl screw centrifuge according to one of the preceding claims, characterized in that the projections (27) and/or the metal plate accommodating the projections consist of steel, cast metal, a plastic material or rubber.

20. Solid bowl screw centrifuge having
a rotating drum (21) which surrounds a centrifuging chamber (19) having a screw (1) which also rotates,
having a distributor (15) preferably constructed as a tube for introducing the material (S) to be centrifuged into the centrifuging chamber (19), which distributor (15) is oriented in an angular manner, particularly perpendicularly, with respect to the center axis (A) of the screw (1),
the material to be centrifuged being guided through an axially extending inflow tube (13) into the distributor (15),
characterized in that
at least one wall (15a) of the distributor is provided with a step-type surface structure—step construction (427)—which extends in the circumferential direction.

21. Solid bowl screw centrifuge according to one of the preceding claims, characterized in that the step construction (427) consists of several metal plates (428) resting on/against one another in the circumferential direction.

22. Solid bowl screw centrifuge according to one of the preceding claims, characterized in that the step construction (427) consists of a one-piece metallic or plastic body.

23. Solid bowl screw centrifuge according to one of the preceding claims, characterized in that the metal plates (428) have an angular cross-section and each consist of a section (428a) extending essentially parallel to the distributor wall and of a section (428b) which is at an angle thereto.

24. Solid bowl screw centrifuge according to one of the preceding claims, characterized in that the section (428a) of the first metal plate (428) which extends essentially parallel to the distributor wall is placed directly onto the distributor wall, and in that the sections of the metal plates (428) which follow, which sections extend parallel to the distributor wall (428a), are each mounted on the back sides of the angular sections (428b) of the preceding metal plates, so that a swirling space is created between the successive metal plates (428).

25. Solid bowl screw centrifuge according to one of the preceding claims, characterized in that the step construction is designed such that the section (429a) of each step (429), which section (429a) extends essentially parallel to the distributor wall, in each case, adjoins the end of the angular section (429b) of the preceding step.

26. Solid bowl screw centrifuge according to one of the preceding claims, characterized in that the individual steps (430) are formed by rows (432) of grooves extending essentially parallel to the drum axis, which rows (432) of grooves preferably have an angular cross-section.

27. Solid bowl screw centrifuge according to one of the preceding claims, characterized in that the sections (432a) of the rows (432) of grooves, which each extend essentially parallel to the distributor wall, are essentially situated in a plane.
